(19) United States
(12) Patent Application Publication
(10) Pub. No.: US 2013/0111542 A1
(43) Pub. Date: May 2, 2013

(54) SECURITY POLICY TOKENIZATION

(71) Applicant: Choung-Yaw Michael Shieh, Palo Alto, CA (US)

(72) Inventor: Choung-Yaw Michael Shieh, Palo Alto, CA (US)

(21) Appl. No.: 13/285,814

(22) Filed: Oct. 31, 2011

(51) Int. Cl. G06F 21/00

(52) U.S. Cl. 726/1

(57) ABSTRACT

A method and apparatus is disclosed herein for using one or more dynamic policies that each have one or more parameters that are instantiated with results of applying one or more other policies. In one embodiment, the method comprises storing a set of policies in a memory, wherein at least one of the policies includes one activatable policy that is conditionally activated during run-time, receiving network traffic using a network interface, applying at least one other policy in the set of policies to the received network traffic, activating the one activatable policy in response to the received network traffic and using results of applying said at least one other policy, and applying the one activatable policy to subsequently received network traffic.

### FIELD OF THE INVENTION

Embodiments of the present invention are related to network security; more particularly, embodiments of the present invention are related to security policy enforced by a security gateway in a network.

### BACKGROUND OF THE INVENTION

Security policies have been used intensively on security gateways for access control of the protected network. The security policies are composed of parameters of network protocols, such as Internet Protocol (IP) addresses, protocol, port, or virtual local area network (VLAN) information. While the conventional design works fine where the networks remain static, it cannot support the dynamic nature of the emerging technology, such as virtualization and mobility. To support mobility, security policies may only be activated after a specific user is authenticated, or a database server becomes accessible only after an application server replies with the database server's IP address. The conventional security policy cannot support these requirements.

Another example is file server access control. Some file server access control mechanisms require that a user must be authenticated to an authentication server before the user gains access the files of the file server. The accessibility of the file server would depend on the successful authentication of the users. The conventional security policies cannot support conditional policy activation, nor support the dynamic IP address of the users.

### SUMMARY OF THE INVENTION

A method and apparatus is disclosed herein for using one or more dynamic policies that each have one or more parameters that are instantiated with results of applying one or more other policies. In one embodiment, the method comprises storing a set of policies in a memory, wherein at least one of the policies includes one activatable policy that is conditionally activated during run-time, receiving network traffic using a network interface, applying at least one other policy in the set of policies to the received network traffic, activating the one activatable policy in response to the received network traffic and using results of applying said at least one other policy, and applying the one activatable policy to subsequently received network traffic.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a network.

FIG. 2A is a view of an example security policy with tokens in policy B.

FIG. 2B is a view of the security policies after two connections match policy A.

FIG. 3 illustrates an additional example of security policies that include tokens.

FIG. 4 is a dataflow diagram of one embodiment of a process for access control.

FIG. 5 depicts a block diagram of a security gateway, such as security gateway 150 of FIG. 1.

FIG. 6 illustrates a set of programs and data that is stored in memory of one embodiment of a security gateway, such as the security gateway set forth in FIG. 5.

### DETAILED DESCRIPTION OF THE PRESENT INVENTION

A method and apparatus for using security policy that employs tokens in place of parameters are described. More specifically, embodiments of the present invention are related to the design of a security policy in which one or more configuration parameters of the security policy are represented by tokens. The configuration parameters of the policy, include, for example, the source IP address, source port number, destination IP address, or destination port number. In one embodiment, each of the tokens are replaced by the result of another security policy, such as, for example, the source IP address of a user authentication connection, or the IP address in the PORT command of a FTP connection. In one embodiment, the replacements may occur in real time to create a flexible dynamic policy to support complicated security requirements and to support dynamic values of the connections.

The advantages of embodiment of the present invention include, without limitation, allowing the definition of dynamic security policies based on real time network connections and activating dynamic policies based on run-time information, to provide better protections in the dynamic networks. That is, the dynamic policies are activated by real time states, thereby providing better protection for the enterprise networks, which need more advanced security mechanism to protect their networks from sophisticated attacks. Thus, this policy tokenization described herein provides an effective way to configure dynamic security policies that fulfill the needs of network security and compliance and provides a flexible framework that allows administrators to define policies compliant to their security requirements.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### An Example of A Network

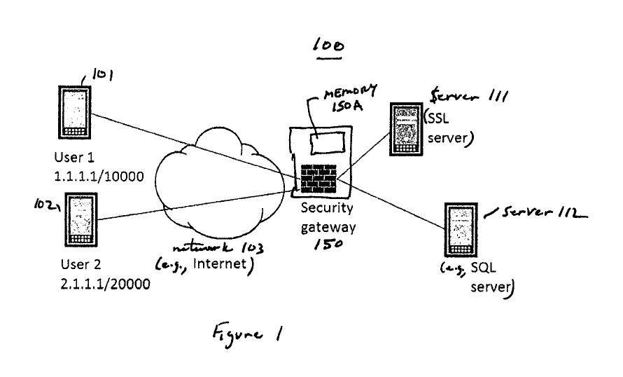

FIG. 1 is a block diagram depicting a network architecture 100 in which client systems 101 and 102, as well as servers 111 and 112 (any of which can be implemented using a computer system), are coupled to a network 103. Servers 111 and 112 are coupled to network 103 via security gateway 150. Note that network 100 may include more or less than two client devices and servers. Also the network 100 may include more than one security gateway.

In one embodiment, clients 101 and 102, security gateway 150, and servers 111 and 112 implemented with a computer system include a modem, network interface or some other method can be used to provide connectivity to network 103. Client systems 101 and 102 are able to access information on servers 14 and 102 using, for example, a web browser or other client software (not shown). Such a client allows client systems 101 and 102 to access data hosted by servers 111 and 112 or one of storage devices in the network. While FIG. 1 depicts the use of a network such as the Internet for exchanging data between clients, the security gateway and servers, the techniques described herein are not limited to the use of the Internet or any particular network-based environment.

### Overview of Policies With Tokens

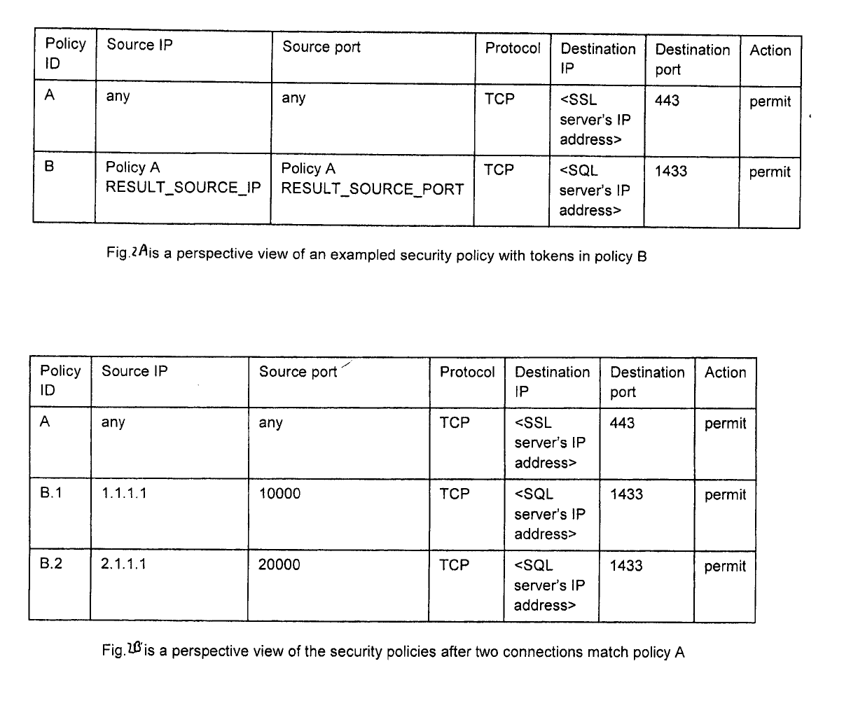

FIG. 2A shows an example security policy with the typical parameters. Security gateways apply the configured actions (e.g., permit) for all packets that match the security policies. In one embodiment, tokens are used in the place of the parameters of security policy, where the tokens are replaced with the results of a traffic match with another security policy. Referring FIG. 2A, policy A is composed of static parameters, and policy B has tokens in the parameters of source IP address and source port. When the traffic matches policy A as determined by the security gateway, the security gateway populates the source IP address and source port value to RESULT_SRC_IP and RESULT_SRC_PORT of policy A. Then, the tokens in policy B are replaced with the values of RESULT_SRC_IP and RESULT_SRC_PORT in policy A to generate a dynamic policy based on policy B.

FIG. 2B shows how the tokens generate dynamic policies. If there is another connection match policy A, the security gateway uses the result of RESULT_SRC_IP and RESULT_SRC_PORT to populate another dynamic policy based on policy B. In this case, the results of applying policy B cause 2 different dynamic policies to be generated, each allowing the user to create a connection to the SQL server after it connects to the SSL server in policy A.

In more detail, still referring to FIG. 2B, in one embodiment, the security gateway applies that results returned from the policies. The results could be the parameters in layer 3 IP protocol, such as IP address and ports, or they could be from layer 7 application protocols, such as user name in FTP or user agents in HTTP. The results of these policies are used in the place of the tokens in another policy to generate dynamic policies. This provides the flexibility that a policy could be activated by a specific user or role, from a certain IP address, or only accessible from a certain browser.

In further detail, still referring FIG. 2B, the connections from a dynamic policy are permitted from the result of the parent connections. When the parent connections disconnect, the corresponding dynamic policy is gone. The connections of a dynamic policy may be terminated due to the termination of the dynamic policy, or they can keep alive until connections timeout, depending on the enterprise's security policy. Embodiments of the invention apply to both conditions.

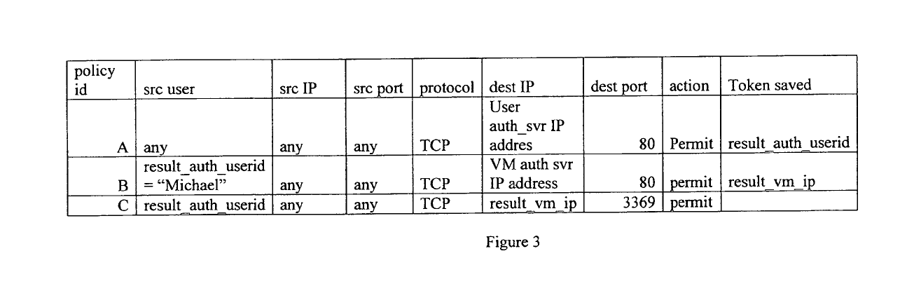

FIG. 3 illustrates an additional example of security policies that include tokens. Referring to FIG. 3, the security gateway applies policy A to the incoming traffic, which results in the application configuration parameter to set the variable result_auth_userid equal to a name associated with an application. In this example, the name indicated with the application is the user id called “ Michael”. This causes the security gateway to activate policy B and set the source user value equal to the value that was set (e.g., Michael) as a result of applying policy A. Thereafter, when new network traffic is received and it has the auth user ID equal to “Michael”, the application of policy B causes the security gateway to give access to the VM authentication Server at the IP address specified in the destination IP field of the table in FIG. 3, which activates policy C. Now, the users “Michael” can access the retuned VM IP address through policy C

Note that the variable, such as result_auth_userid, could be a group of values. Every connections to the User Authentication server in policy A will add a new value to result_auth_userid. If there are multiple connections matching policy A, result_auth_userid could be the group of values from each of the connections.

Note that in all the examples in FIGS. 2A, 2B, 3, if the initially applied policy, such as policy A, is not triggered during run-time, then the activatable policy, (e.g., policy B in FIG. 2A) is never enabled.

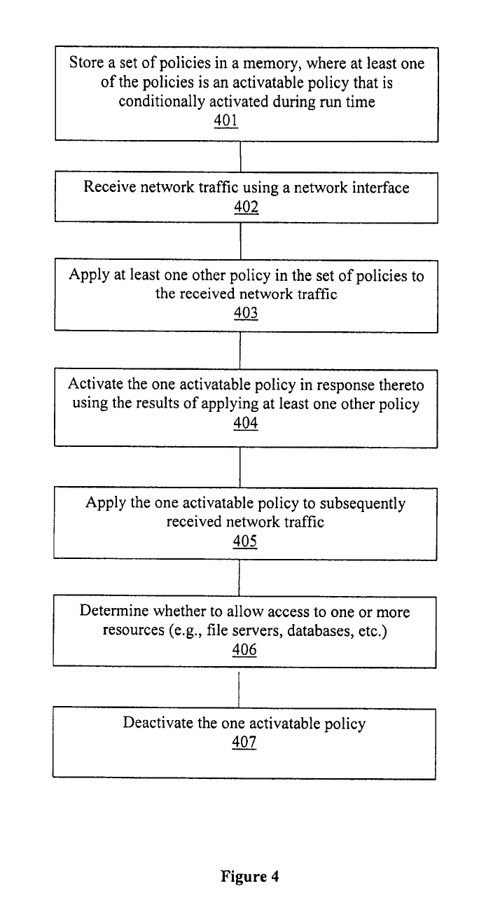

FIG. 4 is a dataflow diagram of one embodiment of a process for access control. The process is performed by processing logic that may comprise hardware (circuitry, dedicated logic, etc.), software (such as is run on a general purpose computer system or a dedicated machine), or a combination of both. In one embodiment, the process is performed by a security gateway in a network.

Referring to FIG. 4, the process begins by processing logic storing a set of policies in a memory, where at least one of the policies is an activatable policy that is conditionally activated during run time (processing block 401). In one embodiment, the memory is in security gateway.

Next, processing logic receives network traffic using a network interface (processing block 402). In one embodiment, the network interface is the network interface for a security gateway

In response to receipt of the network traffic, processing logic applies at least one other policy in the set of policies to the received network traffic (processing block 403) and activates the one activatable policy in response thereto using the results of applying those other policies (processing block 404). In one embodiment, activating the one activatable policy comprises replacing one or more tokens in the activatable policy with one or more values that result from previously applying the one or more other policies, where each of the tokens represents a configuration parameter in the policy. In one embodiment, the configuration parameter is one from a group consisting of the source IP address, source port number, destination IP address, destination port number, protocol, or application. In another embodiment, the configuration parameter also includes any data from application protocols, including but not limited to, one or more of a URL or user agent in a header (e.g., an HTTP header), sender or recipient of SMTP, caller or callee in a connection request (e.g., IP_Address in a get-desktop-connection Request in a VMware View protocol).

After activating the one activatable policy, processing logic applies the one activatable policy to subsequently received network traffic.

Based on the results of applying the one activatable policy, processing logic determines whether to allow access to one or more resources (e.g., file servers, databases, etc.) (processing block 406). In one embodiment, the received traffic is a request for accessing some data or service available from a server or database and the security gateway determines whether to grant access based results of applying the activatable policy (after its been activated).

Subsequently, processing logic deactivates the one activatable policy (processing block 407). In one embodiment, the one activatable policy is deactivated in response to ending a session or a connection. In one embodiment, the one activatable policy is deactivated in response to termination of one or more policies whose results were used to activate the one activatable policy.

### An Example of A Security Gateway

In one embodiment, the security gateway comprises a memory, a network interface and a processor. The memory stores a set of policies, including at least one one policy that is conditionally activated during run-time (i.e., an activatable policy). The network interface receives network traffic during run-time. The processor applies at least one other policy in the set of policies to the received network traffic, activates an activatable policy in response to the received network traffic and using results of applying said at least one other policy, and applies the one activatable policy to subsequently received network traffic. In one embodiment, the processor determines whether to allow access to a resource (e.g., a server, a database, etc.) based on results of applying the one activatable policy.

In one embodiment, the processor activates the one activatable policy by replacing one or more tokens in the one activatable policy with one or more values that result from applying the at least one other policy, where each of the one or more tokens represents a configuration parameter in the one policy. In one embodiment, the configuration parameter comprises a source internet protocol (IP) address, source port number, destination IP address, destination port number, protocol, and/or an application.

In one embodiment, the processor deactivates the one activatable policy after applying the one activatable policy to subsequently received network traffic. The policy may be deactivated in response to ending a session or a connection. Also, the policy may be deactivated in response to termination of the at least one other policy. For example, the security gateway monitors a session and when the session ends, the security gateway deactivates any policy that was activated based on that session. For example, in FIG. 2B, 2 dynamic policies were added in the result of 2 sessions matching policy A. When one session is terminated or expires, the related dynamic policy is removed from the table in FIG. 2B which in effect deactivates the (dynamic) policy.

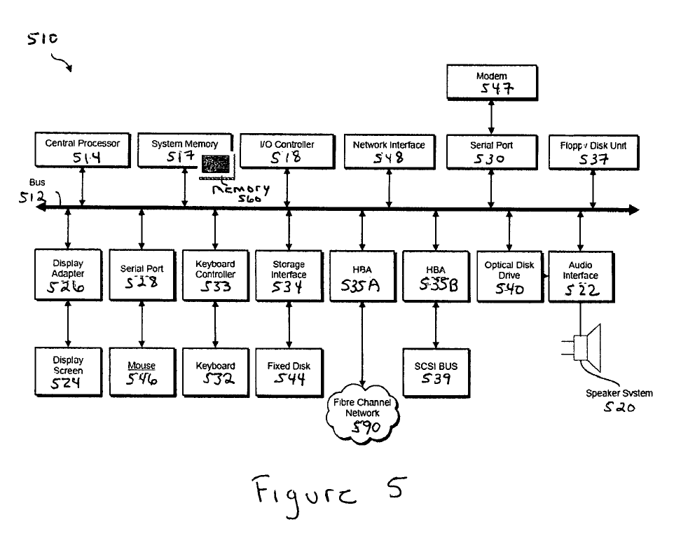

FIG. 5 depicts a block diagram of a security gateway, such as security gateway 150 of FIG. 1. Referring to FIG. 5, security gateway 510 includes a bus 512 to interconnect subsystems of security gateway 510, such as a processor 514, a system memory 517 (e.g., RAM, ROM, etc.), an input/output controller 518, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540. Also included are a mouse 546 (or other point-and-click device, coupled to bus 512 via serial port 528), a modem 547 (coupled to bus 512 via serial port 530), and a network interface 548 (coupled directly to bus 512).

Bus 512 allows data communication between central processor 514 and system memory 517. System memory 517 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a computer readable medium, such as a hard disk drive (e.g., fixed disk 544), an optical drive (e.g., optical drive 540), a floppy disk unit 537, or other storage medium.

Storage interface 534, as with the other storage interfaces of computer system 510, can connect to a standard computer readable medium for storage and/or retrieval of information, such as a fixed disk drive 544. Fixed disk drive 544 may be a part of computer system 510 or may be separate and accessed through other interface systems. Modem 547 may provide a direct connection to a remote server via a telephone link or to the Internet via an internet service provider (ISP). Network interface 548 may provide a direct connection to a remote server via a direct network link to the Internet via a POP (point of presence). Network interface 548 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 5 need not be present to practice the techniques described herein. The devices and subsystems can be interconnected in different ways from that shown in FIG. 5. The operation of a computer system such as that shown in FIG. 5 is readily known in the art and is not discussed in detail in this application.

Code to implement the techniques described herein can be stored in computer-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, or another known operating system. System memory 517 stores a list of policies as described above, one or more of which include one or more tokens, or placeholders, for values that are instantiated with a result or results of application of one or more other policies.

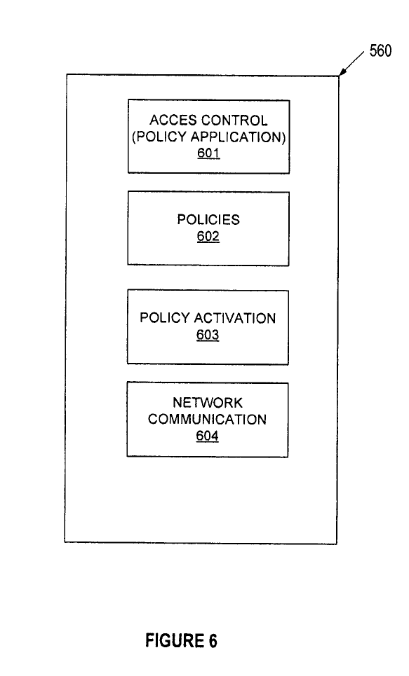

FIG. 6 illustrates a set of code (e.g., programs) and data that is stored in memory of one embodiment of a security gateway, such as the security gateway set forth in FIG. 5. The security gateway uses the code, in conjunction with a processor, to implement the necessary operations (e.g., logic operations) to implement the dynamic policy activation and application.

Referring to FIG. 6, the memory 560 includes an access control module 601 which when executed by a processor is responsible for performing access control including applying policies to incoming traffic. The memory also stores the policies 602, such as policies described above, including activatable policies. The memory also stores the policy activation module 603 which, when executed by a processor, is responsible for activating policies based on results of applying one or more other policies. The memory also includes a network communication module 604 used for performing network communication and communication with the other devices (e.g., servers, clients, etc.).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
storing a set of policies in a memory, wherein at least one of the policies includes one activatable policy that is conditionally activated during run-time;
receiving network traffic using a network interface;
applying at least one other policy in the set of policies to the received network traffic;
activating the one activatable policy in response to the received network traffic and using results of applying said at least one other policy; and
applying the one activatable policy to subsequently received network traffic.

2. The method defined in claim 1 wherein activating the one activatable policy comprises replacing one or more tokens in the one activatable policy with one or more values that result from applying the at least one other policy, where each of the one or more tokens represents a configuration parameter in the one policy.

3. The method defined in claim 2 wherein the configuration parameter comprises one selected from a group consisting of: source internet protocol (IP) address, source port number, destination IP address, destination port number, protocol, application, and meta data from application protocols.

4. The method defined in claim 1 further comprising deactivating the one activatable policy after applying the one activatable policy to subsequently received network traffic.

5. The method defined in claim 4 wherein the one activatable policy is deactivated in response to ending a session or a connection.

6. The method defined in claim 4 wherein the one activatable policy is deactivated in response to termination of the at least one other policy.

7. The method defined in claim 1 further comprising determining whether to allow access to one or more resources based on results of applying the one activated policy.

8. A security gateway for using a network, the security gateway comprising:
a memory to store a set of policies, wherein at least one of the policies includes one activatable policy that is conditionally activated during run-time;
a network interface to receive network traffic; and
a processor operable to
apply at least one other policy in the set of policies to the received network traffic,
activate the one activatable policy in response to the received network traffic and using results of applying said at least one other policy, and
apply the one activatable policy to subsequently received network traffic.

9. The security gateway defined in claim 8 wherein the processor activates the one activatable policy by replacing one or more tokens in the one activatable policy with one or more values that result from applying the at least one other policy, where each of the one or more tokens represents a configuration parameter in the one policy.

10. The security gateway defined in claim 9 wherein the configuration parameter comprises one selected from a group consisting of: source interne protocol (IP) address, source port number, destination IP address, destination port number, protocol, application, and meta data from application protocols.

11. The security gateway defined in claim 8 wherein the processor is operable to deactivate the one activatable policy after applying the one activatable policy to subsequently received network traffic.

12. The security gateway defined in claim 11 wherein the one activatable policy is deactivated in response to ending a session or a connection.

13. The security gateway defined in claim 11 wherein the one activatable policy is deactivated in response to termination of the at least one other policy.

14. The security gateway defined in claim 8 wherein the processor is operable to determine whether to allow access to a resource based on results of applying the one activatable policy.

15. An article of manufacture having one or more non-transitory computer readable media storing instructions thereon which, when executed by a security gateway, cause the security gateway to perform a method comprising:
storing a set of policies in a memory of the security gateway, wherein at least one of the policies includes one activatable policy that is conditionally activated during run-time;
receiving network traffic using a network interface of the security gateway;
applying at least one other policy in the set of policies to the received network traffic;
activating the one activatable policy in response to the received network traffic and using results of applying said at least one other policy; and
applying the one activatable policy to subsequently received network traffic.

16. The article of manufacture defined in claim 15 wherein activating the one activatable policy comprises replacing one or more tokens in the one activatable policy with one or more values that result from applying the at least one other policy, where each of the one or more tokens represents a configuration parameter in the one policy.

17. The article of manufacture defined in claim 16 wherein the configuration parameter comprises one selected from a group consisting of: source interne protocol (IP) address, source port number, destination IP address, destination port number, protocol, application, and meta data from application protocols.

18. The article of manufacture defined in claim 15 wherein the method further comprises deactivating the one activatable policy after applying the one activatable policy to subsequently received network traffic.

19. The article of manufacture defined in claim 18 wherein the one activatable policy is deactivated in response to ending a session or a connection.

20. The article of manufacture defined in claim 18 wherein the one activatable policy is deactivated in response to termination of the at least one other policy.
